(19) United States
(12) Patent Application Publication
(10) Pub. No.: US 2002/0107627 A1
(43) Pub. Date: Aug. 8, 2002

(54) Trailer and simulator

(75) Inventors: Scott Funke, Farmington, MI (US); Mark W. Plansinis, Dearborn Heights, MI (US); Pahngroc Oh, Ann Arbor, MI (US); Stephen M. Stachowski, Canton, MI (US)

Correspondence Address: David W. Okey, BRINKS HOFER GILSON & LIONE, P.O. Box 10395, Chicago, IL, 60610, US

(73) Assignee: Visteon Global Technologies, Inc.

(21) Appl. No.: 09/992,395

(22) Filed: Nov. 6, 2001

Related U.S. Application Data
(60) Provisional application No. 60/253,894, filed on Nov. 29, 2000.

(51) Int. Cl. B60T 13/00; G06F 19/00

(52) U.S. Cl. 701/70; 701/50

(57) ABSTRACT

A simulator for a trailer incorporates sensors on both the trailer and a tow vehicle towing the trailer to measure operating parameters of both the trailer and the tow vehicle or prime mover. A computer mounted in the trailer or in the tow vehicle gathers input data from the sensors, including a variety of measurements of force, displacement, and temperature for the tow vehicle, the trailer, and their components. The computer may also be used to apply braking forces to the wheels of the trailer. Using the simulator, a variety of components on the trailer may be tested, their performance measured, and a better trailer may be designed. A trailer may also incorporate such a system for better control of the trailer and the combination vehicle of which it is a part.

This application claims priority to and the benefit of Provisional Application No. 60/253,894, filed Nov. 29, 2000, entitled, “Trailer Simulator System and Operating Method,” which is hereby incorporated by reference.

### FIELD OF THE INVENTION

The present invention relates to automotive vehicles, and in particular to a simulator for towed automotive vehicles, such as trailers and semi-trailers, and a method of operating said trailers.

### BACKGROUND OF THE INVENTION

Trailers play an important role in the transportation of goods. In addition to the great variety of trailers used in Class 7 and 8 heavy truck transports, there are many trailers of a smaller nature, such as those towing boats, household goods, harvested crops, automobiles, and so on. The proper design of trailers is necessary for their safe and economical operation, both on and off the highway. This is especially important with the higher speeds now allowed on interstate and non-interstate highways. What is needed is a trailer simulator that will allow designers to quickly determine how best to modify a trailer and to provide the components and parameters for the optimum control and performance of the trailer.

### BRIEF SUMMARY

In one embodiment of the present invention, a trailer simulator for towing behind a tow vehicle or prime mover is provided. The trailer simulator comprises a trailer chassis, including an attachment for towing, such as a trailer hitch, and at least two wheels, each wheel further including at least one brake. Each wheel is mounted on an axle, and the axle may be common to both wheels. More wheels and more axles are possible in other embodiments. There is also a brake controller, for controlling the at least one brake on each of two wheels. The trailer further has at least one sensor for measuring a parameter of steering and braking, and a computer for receiving inputs from the at least one sensor and for sending outputs to the at least one brake controller. Using the trailer simulator, a user tests performance parameters of a trailer.

The invention may be further embodied in a trailer for towing behind a prime mover. The trailer comprises a trailer chassis, an attachment for towing, and at least two wheels, each wheel further comprising at least one brake. The trailer also comprises at least one brake controller for controlling the brakes, and at least one sensor for measuring a parameter of steering and braking the combination vehicle. There is a also a computer for receiving inputs from the at least one sensor and sending outputs to the at least one brake controller, wherein a user controls braking and steering of a trailer. A controller will control an actuator that applies an input from a brake to a wheel of the trailer or trailer simulator.

Another embodiment is a method of operating a combination vehicle having a tow vehicle or prime mover, a trailer, and a separately controlled brake on at least two wheels of the trailer. The method includes steps of driving the combination vehicle and detecting operating parameters of the combination vehicle. The operator then applies a braking force to each wheel by means of a trailer control system in response to the operating parameters to control a force on the trailer. The force is selected from the group consisting of a braking force, a yaw torque force, and a rollover force.

Many other embodiments of the invention are possible.

### BRIEF DESCRIPTION OF SEVERAL VIEWS OF THE DRAWINGS

FIG. 1 depicts braking with and without a combination vehicle stability program.

FIG. 2 depicts a lane change for a combination vehicle, with and without a combination vehicle stability program.

FIG. 3 depicts yaw torque control in a combination vehicle.

FIG. 4 depicts a coordinate system for a combination vehicle.

FIG. 5 is an isometric view of an embodiment of a trailer simulator.

FIG. 6 is a schematic diagram of a tow vehicle and a trailer simulator.

FIG. 7 is a top view of a tow vehicle and a trailer.

FIG. 8 is a flowchart for a method of operating a combination vehicle.

### DETAILED DESCRIPTION OF THE PRESENTLY PREFERRED EMBODIMENTS

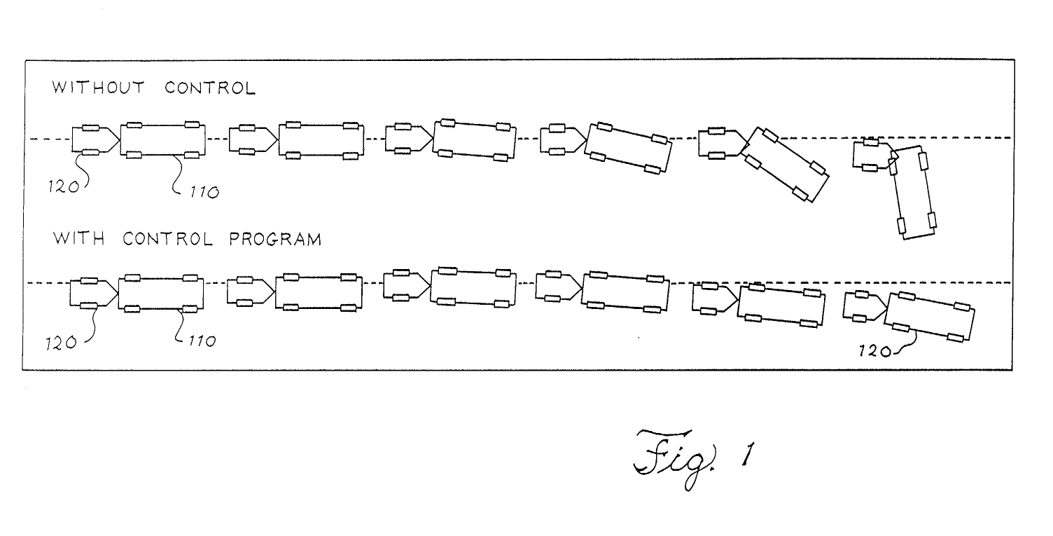

FIG. 1 depicts possible situations in operation of a combination vehicle having a prime mover 110 and a trailer 120. In the upper sequence, the tow vehicle and its trailer may experience a jack-knife response to a 0.5 g deceleration (hard braking) applied by the driver of the tow vehicle. The upper sequence depicts a vehicle without a combination vehicle stabilization or control program. The lower sequence, by contrast, shows a much more controlled response and much less jack-knifing when the same deceleration is applied, but a control program is in use to control the motion of the trailer.

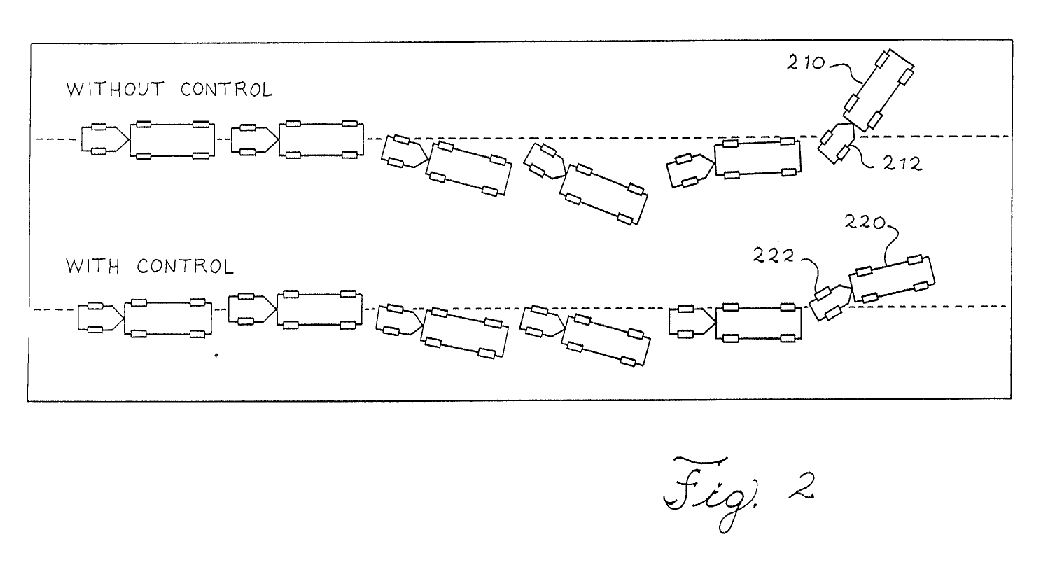

FIG. 2 depicts another situation in which combination vehicle stability is in question. The upper sequence depicts a lane change situation for a combination prime mover 210—trailer 212 vehicle attempting a lane change. In this situation, lateral forces on the trailer and the truck have combined to move the combination vehicle in a manner that is presumably not desired by the operator. The lower sequence depicts a combination prime mover 220 trailer 222 having a control program. In the lower sequence, the combination vehicle with the control program is better able to control side forces and guide the combination vehicle in the desired direction.

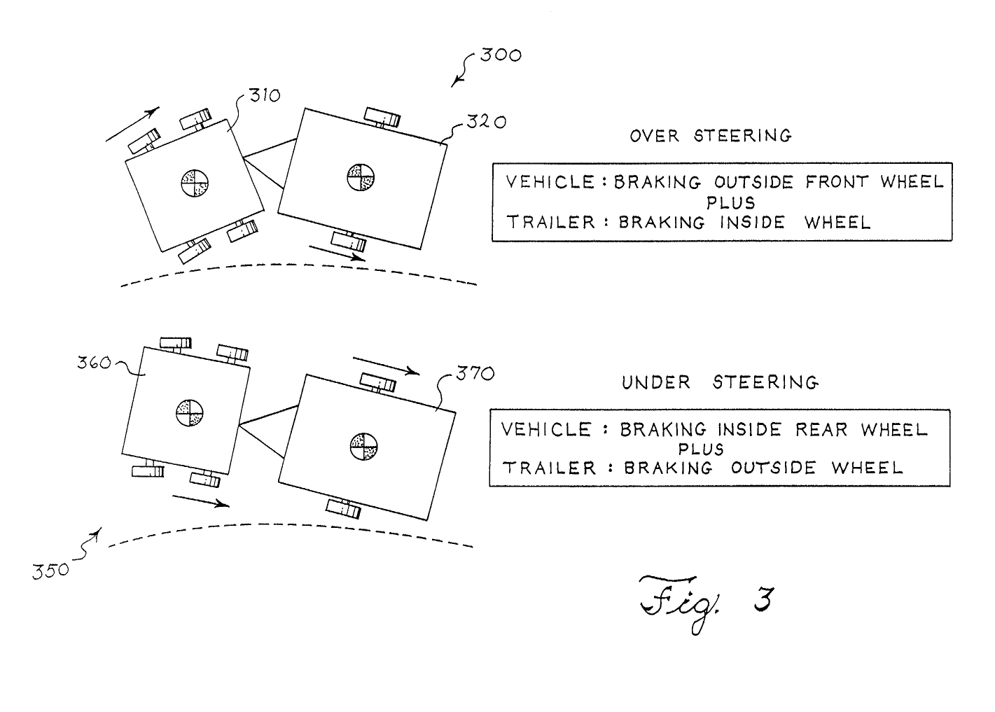

FIG. 3 depicts the nature of at least one problem encountered when a combination vehicle changes direction. The vehicle may change direction in an intentional manner, as in making a turn or changing a lane of traffic. The vehicle may also change direction unintentionally, for instance, when the driver decelerates rapidly. In this latter case, a direction change is not desired, but when the direction change occurs it must be controlled or the result may be as depicted in FIGS. 1 or 2. The combination vehicle in the upper sequence 300 demonstrates over-steering while making a left turn. In this example, the driver has turned the wheels too far to the left, causing the prime mover 310 to move too far to the left and the trailer 320 to move too far to the right. The combination vehicle, and in particular the trailer, now needs less motion to the left and more to the right. One way to achieve this steering is to selectively apply the brakes to the outside front wheel of the prime mover 310 and to the inside wheel of the trailer 320.

In a similar manner, the lower portion of FIG. 3 depicts under-steering, in which a combination vehicle 350 is turning left, but has not turned sharply enough. In this situation, the correct bearing for the combination vehicle, and especially for the trailer, may be achieved by selectively applying the brakes. The prime mover 360 should apply brakes to the inside rear wheel, causing the prime mover to turn more sharply to the left. At the same time, the trailer 370 must follow the prime mover and should have a small braking force applied to its outside wheel. This will correct the under-steering situation without jackknifing or loss of control. The actions in FIG. 3 depict yaw torque control. Yaw in this context means side-to-side motion in the plane of the road or highway on which the combination vehicle is operating.

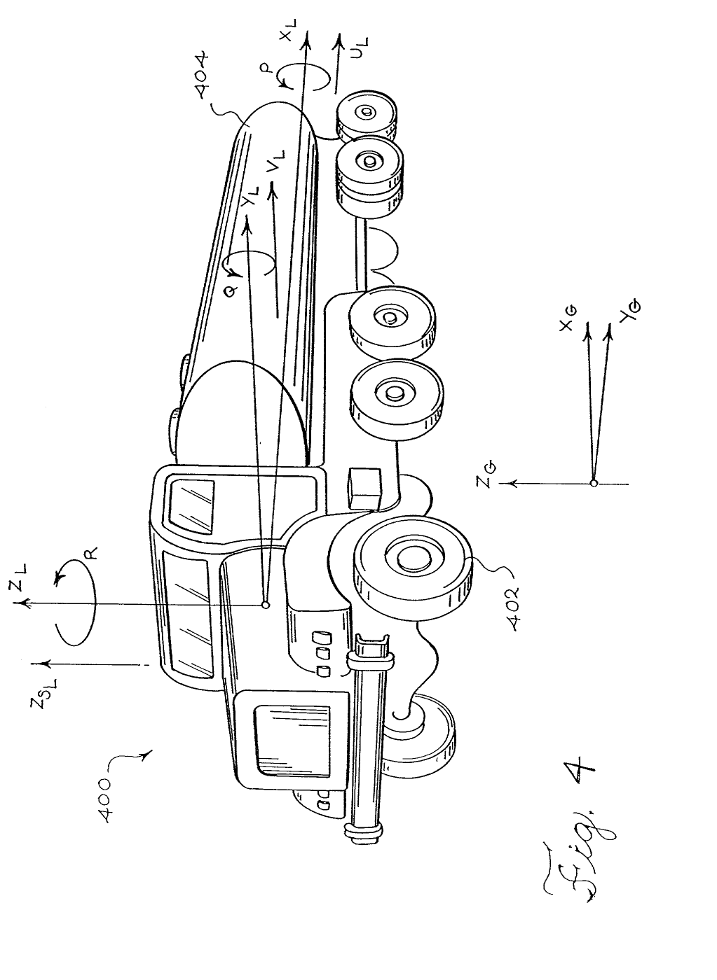

FIG. 4 depicts a coordinate system for a combination vehicle 400, comprising a tractor 402 and a trailer 404. The Cartesian coordinates X and Y apply to the direction of travel and the lateral direction, respectively, while the Z axis is the vertical axis. CG depicts the center of gravity of the prime mover. Yaw may be depicted as a rotary motion about the Z-axis, that is, motion “r” in FIG. 4, in the plane of the highway, resulting in side-to-side motion. Roll-over forces may be depicted as a rotary motion about the X axis, depicted as roll-over motion “p” in FIG. 4, or as rotary motion about the Y-axis, depicted as flipping motion “q” in FIG. 4. Roll-over forces for combination vehicles are more likely to turn the vehicle over laterally, that is on the side, rather than flipping the entire vehicle front-to-back or back-to-front, although such a situation may be possible in mountain driving or other unusual operating conditions. For the most part, however, roll-over forces will tend to be those along the X-axis, rotary motion “p,” tending to turn the combination vehicle on its side. The trailer simulator should thus be useful in controlling braking forces, yaw forces, and rollover forces. Yaw forces are sometimes called yaw torque forces.

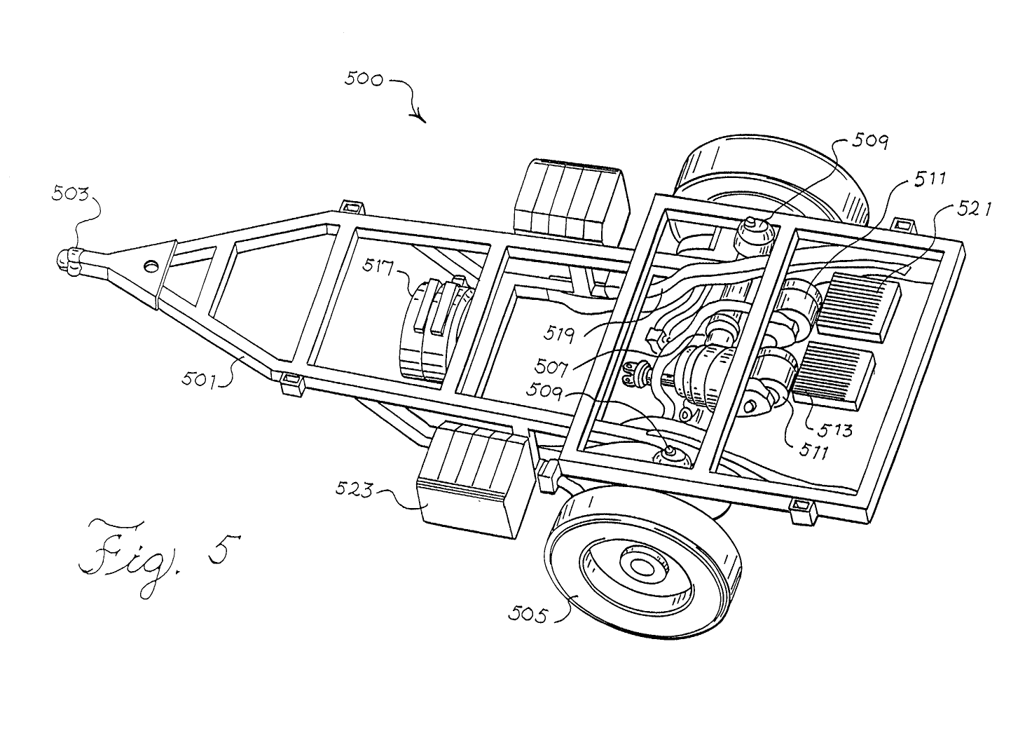

FIG. 5 depicts a trailer simulator 500 used for measuring forces and improving performance of a combination vehicle. The trailer simulator includes a chassis 501 having a point of attachment 503 or hitch for joining to a prime mover or tow vehicle (not shown). The trailer simulator has at least two wheels 505, the wheels mounted on an axle 507, which may be common to the two wheels, or may be a separate axle for each wheel. In one embodiment, an electric drum brake 509 is coupled to each wheel. The coupling may be via mechanical components, including a sprocket set 513 and chain 515, or via a planetary gear system (not shown). The coupling enables the motor to apply a “braking force” through mechanical means to either a drum brake or a caliper brake on the wheel. Other brakes may also be present on the trailer simulator, including a variable reluctance brake (not shown). A variable reluctance brake functions largely as an electric brake, but with an added performance advantage in that variable reluctance sensors allow very tight control over the amount of force applied by each brake. The trailer simulator also has a torque biasing unit 517 for distributing torque as desired among the trailer wheels. An eddy current brake 519 provides measured, controllable braking torque rather than conventional friction-material based braking. These components allow for measuring the performance of each brake or actuator used in the trailer simulator. Of course, the performance of more than one actuator at a time may also be measured.

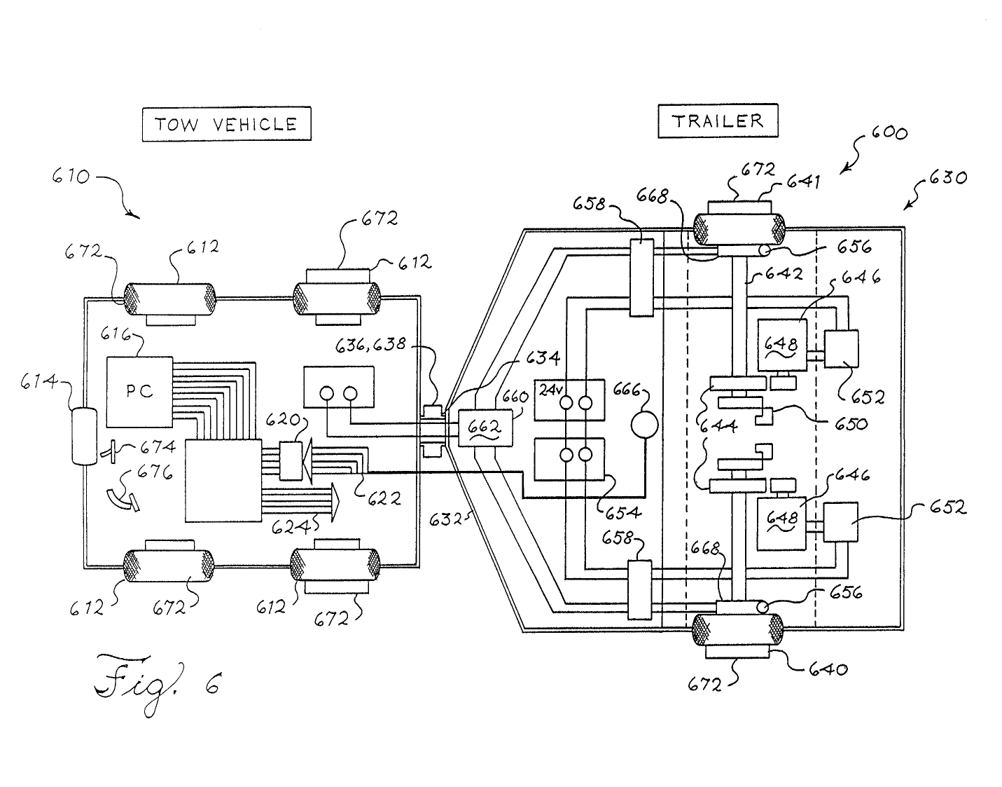

FIG. 6 depicts a schematic representation of another embodiment of a combination vehicle 600. The combination vehicle includes a prime mover or tow vehicle 610. The prime mover may include four or more wheels 612, a vehicle speed sensor 614 and an onboard computer 616, the computer 616 in communication with a microprocessor 618 for controlling braking of the trailer 630 of the combination vehicle 600. The controller 618 may be a microprocessor controller, or may be any computer with sufficient processing and memory capabilities to accomplish the task of controlling the braking of the trailer of the combination vehicle. In one embodiment, the trailer or trailer simulator may also include a signal conditioner 620 for receiving sensor inputs 622 from the trailer of the combination vehicle. The signal conditioner may isolate, filter, add an offset, subtract an offset, apply a gain, digitize, or otherwise condition or modify the signals 622 from the sensors. In one embodiment, the conditioned or digitized signals are then sent from the conditioner 620 to the microprocessor 618 for processing into outputs or commands 624 to the trailer brakes. A digital signal processor may also be sufficient for this task. In this embodiment, the microprocessor 618 controls independently the left wheel 640 and the right wheel 641 of the trailer. In other words, there are two trailer wheels and two control channels, one for the left side wheel or left wheels, and for the right side wheel or right wheels of the trailer.

The trailer 630 is part of the combination vehicle 600. The trailer includes a trailer chassis or frame 632, including a point of attachment 634 to the trailer. The point of attachment desirably includes a force sensor 636 and a string potentiometer 638. The force sensor may be a strain gauge or other instrument or sensor capable of measuring and outputting the force between the prime mover 610 and the trailer 630 at the point of attachment 634. A string potentiometer 638 is an instrument that measures and signals the angle between the prime mover and the trailer, the articulation angle. The signals from the force sensor and the string potentiometer are routed to the signal conditioner 620 or to the microprocessor 618 for use in controlling the braking of the trailer.

Trailer 630 also has at least two wheels 640, 641, which may be on a common axle (not shown) or may have independent suspension with individual axles 642. The trailer may also include power transmission components 644 operably connected to the wheels 640, 641. The power transmission components desirably drive motors 646 from a variable reluctance brake 648. The variable reluctance brake functions via the variable reluctance motor, applying more or less resistance to rotation as required. It is useful to have a wheel speed sensor 650, preferably on each wheel of the trailer where control of the braking is desired. Each variable reluctance motor may also have a motor brake driver 652. The driver may be used to control the operation of the variable reluctance brake; the driver may also be used for regenerative braking in which the energy of the motor is used to charge batteries 654. The motor brake drivers 652 controllably communicate with microprocessor 618 via actuator outputs 624, to apply the brakes 648 to the wheels 640, 641 of the trailer 630. The communication may be through connector 658, or may alternatively be through any convenient connector, such as the connector mating with housing 660 for the electric brakes.

Each wheel may alternatively have, or may additionally be equipped with, an electric brake 656. The electric brake may be an electric drum brake or may be a caliper brake. A disconnect or switch 658 may be used to connect the electric drum brake 656 with the electric brake driver 662. An electric brake driver 662 may reside in housing 660, controllably communicating with microprocessor 618 via actuator outputs 624 to control the application of the electric brakes 656.

A sensor group 666 may also reside on the trailer 630, in sensory communication with the microprocessor 618 or the signal conditioner 620. The communication may be through a connector in housing 660 or via a wiring harness 668 between the sensor group 666 and the signal conditioner 620 or the microprocessor 618. The sensor group may contain at least one sensor that measures vehicle yaw rate, longitudinal acceleration, or lateral acceleration. Other sensors that may be useful on the trailer include a temperature sensor 668 on each brake or at least on each wheel 640, 641 of the trailer. The torque sensor 672 may be useful on each wheel 612 of the tow vehicle 610 and also on each wheel 640, 641 of the trailer 630. A torque sensor measures the torque transmitted to the wheel and may be useful in evaluating slip or other driving factors involved in steering and braking. The tow vehicle may also be equipped with a steering wheel angle transducer 674 and a brake pedal sensor 676.

A user then employs a prime mover and a trailer simulator to develop a control scheme so that the brakes on the trailer are applied in such a manner as to avoid jackknifing, to control yaw torque, and to avoid flipping or overturning of the trailer. In one embodiment, the controller 618 uses an algorithm or program for braking force, by sensing information from the hitch force sensor 636, the articulation angle sensor 638, and the speed sensors 650 of trailer wheels 640, 641. The controller then applies the trailer brake 648 or 656, so that the speed of the trailer wheel sensors matches the speed of the vehicle speed sensor 614, with the force sensor 636 not exceeding a desired limit as deceleration occurs.

If braking occurs too rapidly, and an angle appears between the tow vehicle 610 and the trailer 630, yaw torque control may be needed. In this case, there is a yaw rate of the trailer \dot{ω}, a desired yaw rate of the trailer, \dot{ψ} an articulation angle η, and a desired articulation angle η_{d}, between the tow vehicle and the trailer. The desired yaw rate and the desired articulation angle are functions of the steering wheel angle and the longitudinal and lateral braking speeds. Braking torque differentiation is decided by an algorithm, in which

$$IF ( {c}_{1} \vert {{Ψ}^{*}}_{d} - {Ψ}^{*} \vert + {c}_{2} \vert {η}_{d} - η \vert ) > {Y}_{yaw} , \\ THEN {T}_{yaw} = [ {Κ}_{Ψ} - {Κ}_{η} ] [ \begin{matrix}{{Ψ}^{*}}_{d} - {Ψ}^{*} \\ {η}_{d} - η\end{matrix} ] .$$

The trailer simulator also helps prevent rollovers of trailers. One rollover protection algorithm that has been useful in preventing rollovers is

$$IF \vert {c}_{3} ϕ + {c}_{4} {ϕ}^{*} + {c}_{5} {a}_{y} \vert > {Y}_{roll} , \\ THEN {T}_{roll} [ {Κ}_{ϕ} {Κ}_{ϕ} {Κ}_{ay} ] [ \begin{matrix}ϕ \\ {ϕ}^{*} \\ {a}_{{y}_{1}}\end{matrix} ]$$

where c₁, c₂, c₃, c₄ and c₅ are coefficients, φ is the roll angle, \dot{φ} is the roll rate, and a_{y} is the lateral acceleration. Troll is the amount of torque required in each wheel to correct the roll-over tendency. K represents the gain of the appropriate controller. The controller calculates this amount and sends commands to the corresponding actuators to prevent roll-over.

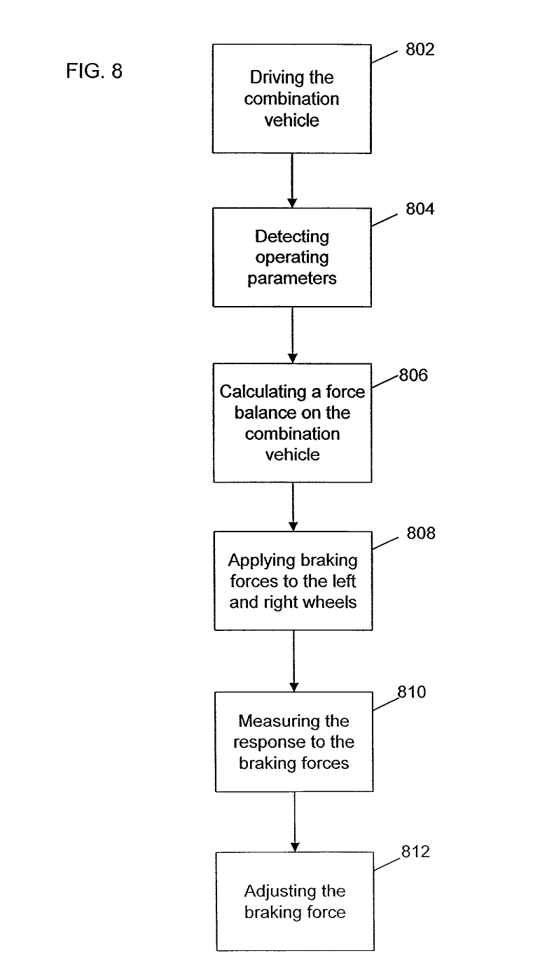

A mathematical model may be constructed for the equations of motion of the combination vehicle, such as a tractor-trailer. In an XYZ coordinate system, per FIG. 8, the tow vehicle or tractor's unsprung mass coordinate is {xu₁, yu₁, zu₁}, where the zu₁ axis passes through the center of gravity of the tractor or tow vehicle. The center of gravity of the tractor is {xs₁, ys₁, zs₁}. In determining roll rates, the controller considers motion of {xu₁, yu₁, zu₁} relative to {xs₁, ys₁, zs₁}. The center of gravity of the trailer is {x₂, y₂, z₂}. In constructing a model, standard equations of motion may be used, including normal equations for kinetic and potential energies of the tractor and the trailer, and conventional coordinate transformation matrices. It has been found useful to develop of equations of motion from Lagrange's equation,

$$\frac{ⅆ}{ⅆ t} \frac{\partial L}{\partial {q}^{*}} - \frac{\partial L}{\partial q} = Q ,$$

where L is the Langrangian operator, q is the generalized coordinate, q is the derivative of the generalized coordinate with respect to time, and Q is the generalized force.

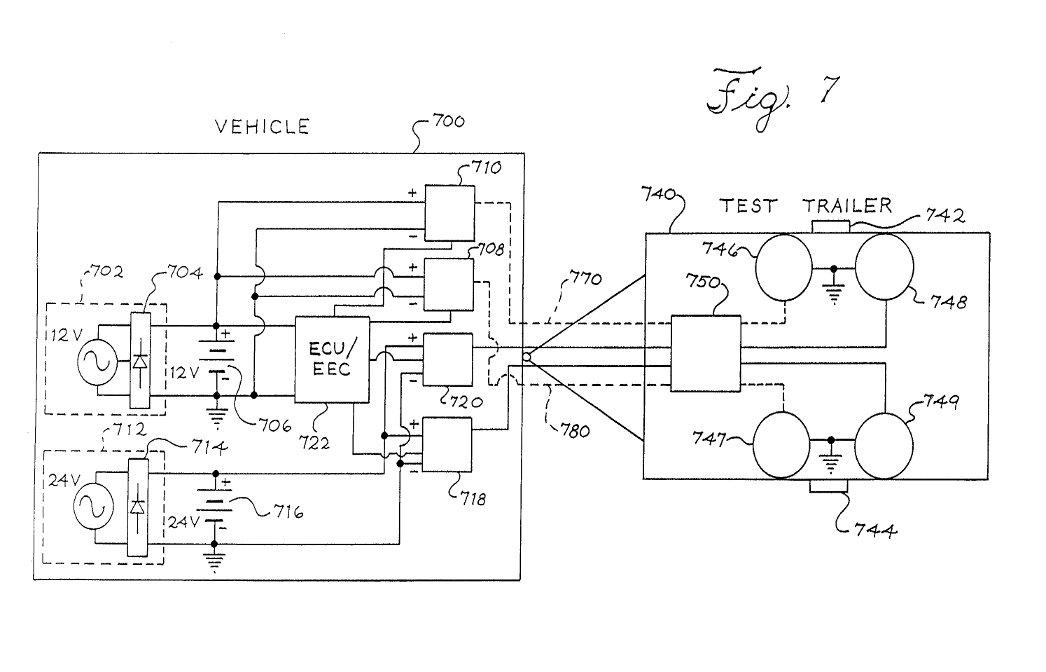

FIG. 7 depicts another embodiment, in which prime mover 700 tows trailer 740 via hitch or point of contact 770. Communication with and control of the trailer may be maintained via wiring harness 780. In this embodiment, the vehicle has a 12V battery 702 with power rectification 704 and a storage battery 706. The power controls electric brakes 746, 747 on wheels 742, 744 for trailer 740 through left side and right side controllers 708, 710. Alternatively, or in addition on a test vehicle, a vehicle alternator 712 may produce 24V of power, rectified by rectifier 714, and stored in storage battery 716. The higher power is more efficient for variable reluctance (VR) brakes. If VR brakes are used on the trailer, they may be controlled by left side and right side VR controllers 718, 720, with VR brakes 748, 749 on wheels 742, 744. Control lines and power lines may be routed through disconnect 750, such as a fail-safe disconnect. A fail-safe disconnect box is installed in the body of the trailer for emergencies. The VR and electric drum brake controllers are in communication with the vehicle electronic control unit (ECU) or vehicle controller 722. The vehicle controller is in sensory contact with sensors on the vehicle and on the trailer, as outlined for FIG. 6.

There are many ways to practice the invention. The embodiments shown have incorporated a wide variety of sensors and equipment to enable users to vary vehicle and trailer performance over a wide range. The trailer may take the form of a semi-trailer as depicted in FIG. 4, or a tow dolly, as in FIG. 6, as well as the form of a cargo trailer, as in FIG. 7. All trailers of these or other types add to the instability of combination vehicles, and better control over the safety of all these vehicles is desired. Using the trailer simulator, the coefficients and parameters used in the above control algorithms can be calculated and refined. Coefficients and parameters may be calculated and applied to particular trailers and types of trailers, and the algorithms may be further refined according to other operating parameters capable of measurement by the sensors used in the trailer simulator. These parameters may include outside weather temperature as measured by a temperature sensor on the trailer simulator, pavement conditions deduced from slip measurements by wheel speed sensors, accelerometers, force sensors, torque sensors, or other sensors mounted on the vehicle or the trailer simulator. Parameters and coefficients developed by the trailer simulator and by the above methods may then be built into control systems for use in controlling trailers in combination vehicles.

FIG. 8 depicts another embodiment, a method of operating a combination vehicle having a trailer with independently controlled left and right wheel braking systems. A driver drives the combination vehicle 802. The combination vehicle may be a test vehicle for gathering data or measuring performance of the combination vehicle, or the combination vehicle may be for commercial or personal non-test use. The sensors and equipment on board the vehicle detect operating parameters 804, such as wheel speeds, yaw rate, and the like. During operation, the on-board computer may calculate continually any number of parameters of operation, including a force balance on the vehicle 806. Calculating the force balance gives the computer instantaneous or continually-updated data on the forward and lateral speed and acceleration of the tow vehicle and the trailer, as well as yaw angles, yaw rate, and so on. When the driver needs to apply the brakes, perhaps to slow down or to make a turn, the trailer braking systems allows the driver to apply the needed braking forces to the left and right wheels of the trailer 808, by applying the brake of the tow vehicle. The sensors and the computer then detect changes and measure the response of the tow vehicle and the trailer to the application of the brakes 810. The changes may include, but are not limited to, changes in individual wheel speeds, yaw angle, yaw rate, rollover forces, accelerations, forces and torques. The method then includes adjusting the braking force 812 to control the combination vehicle and to control braking forces, yaw angles and rates, yaw torque forces, and rollover forces. Using these results, control algorithms may be formulated and refined to better control trailers in combination vehicles.

It is intended that the foregoing description illustrates rather than limits this invention, and that it is the following claims, including all equivalents, which define this invention. Of course, it should be understood that a wide range of changes and modifications may be made to the embodiments described above. Accordingly, it is the intention of the applicants to protect all variations and modifications within the valid scope of the present invention. It is intended that the invention be defined by the following claims, including all equivalents.

What is claimed is:

1. A trailer simulator for towing behind a prime mover for testing performance parameters of a vehicle, the trailer simulator comprising:
a trailer chassis, including an attachment for towing and at least two wheels, each wheel further comprising at least one brake;
at least one brake controller for controlling the at least one brake;
at least one sensor for measuring a parameter of steering and braking;
a computer for receiving inputs from the at least one sensor and sending outputs to the at least one brake controller.

2. The trailer simulator of claim 1, further comprising an electronic control module interposed between the computer and the at least one sensor, wherein the electronic control module receives signals from the at least one sensor and conditions said signals for input to the computer, and the computer outputs said signals to the at least one brake controller.

3. The trailer simulator of claim 1, further comprising a source of electric power for the controller and a connector between the at least one brake and the at least one brake controller.

4. The trailer simulator of claim 1, wherein the at least one brake is selected from the group consisting of a hydraulic brake, an electric drum brake and a variable reluctance brake.

5. The trailer simulator of claim 1, wherein the at least one sensor is selected from the group consisting of a temperature sensor, a yaw rate sensor, an accelerometer, a force sensor, a string potentiometer, a speedometer, a wheel speed sensor, a torque sensor, and a steering-wheel angle sensor, wherein the at least one sensor produces a signal useful for controlling operation of the trailer.

6. The trailer simulator of claim 2, further comprising a digital signal processor connected between the electronic control module and the computer, wherein the digital signal processor receives signals from the electronic control module, processes the signals, and sends the signals to the computer.

7. The trailer simulator of claim 6, wherein the computer controls the speed and direction of the trailer by applying the brakes to the wheels.

8. The trailer simulator of claim 1, further comprising a computer program for interpreting the inputs and calculating outputs,

9. A trailer for towing behind a prime mover, the trailer comprising:
a trailer chassis, including an attachment for towing and at least one left wheel and at least one right wheel, each wheel further comprising at least one brake;
at least one brake controller for controlling the at least one brake;
at least one sensor for measuring a parameter of steering and braking;
a computer for receiving inputs from the at least one sensor and sending outputs to the at least one brake controller, wherein the computer controls application of the left brake and the right brake independently.

10. The trailer of claim 9, further comprising an electronic control module interposed between the computer and the at least one sensor, wherein the electronic control module receives signals from the at least one sensor and conditions said signals for input to the computer, and the computer outputs said signals to the at least one brake controller.

11. The trailer of claim 9, further comprising a source of electric power for the controller and a connector between the at least one brake and the at least one brake controller.

12. The trailer of claim 9, wherein the at least one brake is selected from the group consisting of a hydraulic brake, an electric drum brake and a variable reluctance brake.

13. The trailer of claim 9, wherein the at least one sensor is selected from the group consisting of a temperature sensor, a yaw rate sensor, an accelerometer, a force sensor, a string potentiometer, a speedometer, a wheel speed sensor, a torque sensor, and a steering-wheel angle sensor, wherein the at least one sensor produces a signal useful for controlling operation of the trailer.

14. The trailer of claim 10, further comprising a digital signal processor connected between the electronic control module and the computer, wherein the digital signal processor receives outputs from the electronic control module, processes the outputs, and sends the outputs to the computer.

15. The trailer of claim 14, wherein the computer controls the speed and direction of the trailer by applying the brakes to the wheels.

16. The trailer of claim 9, further comprising a computer program for interpreting the inputs and calculating the outputs.

17. A method of operating a combination vehicle having a prime mover, a trailer, and at least two wheels with separately-controlled brakes on the trailer, the method comprising:
driving the combination vehicle;
detecting operating parameters of the combination vehicle; and
applying a braking force to said wheels with separately controlled brakes in response to the operating parameters, to control a force on the trailer selected from the group consisting of a braking force, a yaw torque force, and a rollover force.

18. The method of claim 17, wherein the operating parameters are selected from the group consisting of a prime mover speed, a prime mover steering wheel angle, a trailer speed, a yaw rate, an acceleration, an articulation angle, a wheel speed, a wheel temperature, a wheel torque, a brake temperature, a brake pedal force, and a trailer hitch force.

19. The method of claim 17, further comprising:
measuring the response of the operating parameters to the braking force; and
adjusting the braking force to avoid understeering, oversteering, jackknifing, or rolling the trailer.

20. The method of claim 19, wherein a signal conditioner receives signals from sensors detecting operating parameters of the combination vehicle, conditions the signals, and transmits the signals for further processing.

21. The method of claim 19, wherein a control system receives signals indicative of operating parameters on the combination vehicle, calculates an output force, and sends a signal to the separately controlled brake on each wheel of the trailer.

22. The method of claim 19, further comprising calculating a force balance on the combination vehicle.
